(19) United States
(12) Patent Application Publication
(10) Pub. No.: US 2002/0012624 A1
(43) Pub. Date: Jan. 31, 2002

(54) Bulk nickel alloy catalysts and process for production of syngas

(76) Inventors: Juan C. Figueroa, Wilmington, DE (US); Anne M. Gaffney, West Chester, PA (US); John E. Anderson, Avondale, PA (US); Ronald H. Mattson SR., Wilmington, DE (US); Donald B. Pierce, Salem, NJ (US); Robert A. Oswald, Milton, DE (US); Roger Song, Wilmington, DE (US)

Correspondence Address: Joanna K. Payne, CONOCO INC., 1000 South Pine 2635 RW, P O Box 1267, Ponca City, OK, 74602-1267, US

(21) Appl. No.: 09/753,100

(22) Filed: Jan. 2, 2001

Related U.S. Application Data
(60) Provisional application No. 60/175,043, filed on Jan. 7, 2000.

(51) Int. Cl. C01B 3/26; C01B 31/18; B01J 23/755

(52) U.S. Cl. 423/418.2; 423/651; 502/337; 420/441; 427/216

(57) ABSTRACT

A method is disclosed for converting light hydrocarbons to synthesis gas employing a reduced nickel alloy monolith catalyst which catalyzes a net partial oxidation reaction. Certain preferred catalysts comprise bulk Ni—Cr, Ni—Co—Cr or Ni—Rh alloy materials. A method of making a bulk nickel alloy catalyst includes depositing a combination of chromium and cobalt metals, or rhodium metal, onto a nickel metal substrate and then thermally diffusing the Cr and Co coating, or the Rh coating, into the atomic lattice of the nickel substrate to produce a bulk Ni—Co—Cr or Ni—Rh alloy monolith catalyst. Preferred 3—D catalyst configurations include perforated foil, metal gauze, metal foam and expanded metal. The catalysts are mechanically strong and self-supporting, and retain high activity and selectivity to carbon monoxide and hydrogen products under syngas production conditions of high flow rate, superatmospheric pressure and high temperature.

### CROSS-REFERENCE TO RELATED APPLICATIONS

This application claims the benefit under 35 U.S.C. § 119(e) of U.S. Provisional Patent Application No. 60/175,043 filed Jan. 7, 2000.

### BACKGROUND OF THE INVENTION

1. Field of the Invention

The present invention generally relates to processes for catalytically converting light hydrocarbons (e.g., natural gas) to a product containing carbon monoxide and hydrogen. More particularly, the invention relates to reduced bulk Ni alloy monolith catalysts capable of catalyzing the net partial oxidation of methane, and to synthesis gas generation processes employing such catalysts.

2. Description of Related Art

Large quantities of methane, the main component of natural gas, are available in many areas of the world, and natural gas is predicted to outlast oil reserves by a significant margin. However, most natural gas is situated in areas that are geographically remote from population and industrial centers. The costs of compression, transportation, and storage make its use economically unattractive.

To improve the economics of natural gas use, much research has focused on methane as a starting material for the production of higher hydrocarbons and hydrocarbon liquids. The conversion of methane to hydrocarbons is typically carried out in two steps. In the first step, methane is reformed with water to produce carbon monoxide and hydrogen (i.e., synthesis gas or syngas). In a second step, the syngas is converted to hydrocarbons, for example, using the Fischer-Tropsch process to provide fuels that boil in the middle distillate range, such as kerosene and diesel fuel, and hydrocarbon waxes. Present day industrial use of methane as a chemical feedstock typically proceeds by the initial conversion of methane to carbon monoxide and hydrogen by either steam reforming, which is the most widely used process, or by dry reforming. Steam reforming proceeds according to Equation 1.

CH₄+H₂O [symbol] CO+3H₂ (1)

Although steam reforming has been practiced for over five decades, efforts to improve the energy efficiency and reduce the capital investment required for this technology continue.

The partial oxidation of hydrocarbons, e.g., natural gas or methane is another process that has been employed to produce syngas. While currently limited as an industrial process, partial oxidation has recently attracted much attention due to significant inherent advantages, such as the fact that significant heat is released during the process, in contrast to the steam reforming processes, which are endothermic. Partial oxidation of methane proceeds exothermically according to the following reaction stoichiometry:

CH₄+½O₂ [symbol] CO+2H₂ (2)

In the catalytic partial oxidation processes, natural gas is mixed with air, oxygen or oxygen-enriched air, and is introduced to a catalyst at elevated temperature and pressure. The partial oxidation of methane yields a syngas mixture with a H₂:CO ratio of 2:1, as shown in Equation 2. This ratio is more useful than the H₂:CO ratio from steam reforming for the downstream conversion of the syngas to chemicals such as methanol and to fuels. Furthermore, oxidation reactions are typically much faster than reforming reactions. This makes possible the use of much smaller reactors for catalytic partial oxidation processes. The syngas in turn may be converted to hydrocarbon products, for example, fuels boiling in the middle distillate range, such as kerosene and diesel fuel, and hydrocarbon waxes by processes such as the Fischer-Tropsch synthesis.

The selectivities of catalytic partial oxidation to the desired products, carbon monoxide and hydrogen, are controlled by several factors, but one of the most important of these factors is the choice of catalyst composition. Difficulties have arisen in the prior art in making such a choice economical. Typically, catalyst compositions have included precious metals and/or rare earths. The large volumes of expensive catalysts needed by the existing catalytic partial oxidation processes have placed these processes generally outside the limits of economic justification.

A number of process regimes have been described in the literature for the production of syngas via catalyzed partial oxidation reactions. The noble metals, which typically serve as the best catalysts for the partial oxidation of methane, are scarce and expensive. The more widely used, less expensive, catalysts have the disadvantage of promoting coke formation on the catalyst during the reaction, which results in loss of catalytic activity. Moreover, in order to obtain acceptable levels of conversion of gaseous hydrocarbon feedstock to CO and H₂ it is typically necessary to operate the reactor at a relatively low flow rate, or space velocity, using a large quantity of catalyst.

For successful operation at commercial scale, however, the catalytic partial oxidation process must be able to achieve a high conversion of the methane feedstock at high gas hourly space velocities, and the selectivity of the process to the desired products of carbon monoxide and hydrogen must be high. Such high conversion and selectivity must be achieved without detrimental effects to the catalyst, such as the formation of carbon deposits (“coke”) on the catalyst, which severely reduces catalyst performance. Accordingly, substantial effort has been devoted in the art to the development of economical catalysts allowing commercial performance without coke formation. Not only is the choice of the catalyst's chemical composition important, the physical structure of the catalyst and catalyst support structures must possess mechanical strength and porosity, in order to function under operating conditions of high pressure and high flow rate of the reactant and product gasses. Another object of continuing efforts in this field is to develop stronger, more porous catalyst supports.

Of the methods that employ nickel-containing catalysts for oxidative conversion of methane to syngas, typically the nickel is supported by alumina or some other type of ceramic support. For example, V. R. Choudhary et al. (J. Catal., Vol. 172, pages 281-293, 1997) disclose the partial oxidation of methane to syngas at contact times of 4.8 ms (at STP) over supported nickel catalysts at 700 and 800° C. The catalysts were prepared by depositing NiO—MgO on different commercial low surface area porous catalyst carriers consisting of refractory compounds such as SiO₂, Al₂O₃, SiC, ZrO₂ and HfO2. Catalysts were also prepared by depositing NiO on the catalyst carriers with different alkaline and rare earth oxides such as MgO, CaO, SrO, BaO, Sm₂O₃ and Yb₂O_{3.}

U.S. Pat. No. 5,149,464 discloses a method for selectively converting methane to syngas at 650° C. to 950° C. by contacting the methane/oxygen mixture with a solid catalyst, which is either:

(a) a catalyst of the formula MₓM′_{y}O_{z} where: M is at least one element selected from Mg, B, Al, Ln, Ga, Si, Ti, Zr and Hf; Ln is at least one member of lanthanum and the lanthanide series of elements, M′ is a d-block transition metal, and each of the ratios x/z and y/z and (x+y)/z is independently from 0.1 to 8. Alternatively, the catalyst is (b) an oxide of a d-block transition metal; or (c) a d-block transition metal on a refractory support; or (d) a catalyst formed by heating a) or b) under the conditions of the reaction or under non-oxidizing conditions. The d-block transition metals are selected from those having atomic number 21 to 29, 40 to 47 and 72 to 79, the metals Sc, Ti, Va, Cr, Mn, Fe, Co, Ni, Cu, Zr, Nb, Mo, Tc, Ru, Rh, Pa, Ag, Hf, Ta, W, Re, Os, Ir, Pt and Au.

U.S. Pat. No. 5,500,149 describes a Ni/Al₂O₃ catalyst that catalyzes the reaction CO₂+CH₄→2CO+2H₂, and demonstrates how reaction conditions can affect the product yield. The partial oxidation of methane to synthesis gas using various transition metal catalysts under a range of conditions has been described by Vernon, D.F. et al. (Catalysis Letters 6:181-186 (1990)). European Pat. App. Pub. No. 640561 discloses a catalyst for the catalytic partial oxidation of hydrocarbons comprising a Group VIR metal on a refractory oxide having at least two cations. Multimonolith combustors are discussed by M.F.M. Zwinkels, et al. in a chapter entitled “Catalytic Fuel Combustion in Honeycomb Monolith Reactors” (Ch. 6, A. Cybulski et al., eds., Structured Catalysts and Reactors. 1998. Marcel Dekker, Inc., pp.149-177.)

European Patent No. EP 303,438 describes a catalytic partial oxidation process for converting a hydrocarbon feedstock to synthesis gas using steam in addition to oxygen. The exemplary reaction is catalyzed by a monolith of Pt—Pd on an alumina/cordierite support. Certain catalyst disks of dense wire mesh, such as high temperature alloys or platinum mesh are also described. Optionally, the wire mesh may be coated with certain metals or metal oxides having catalytic activity for the oxidation reaction.

M.D. Pawson et al. disclosed that Ni gauze is relatively inert as a catalyst for oxidation of methane in air at temperatures of about 1000° C., while Pt and Pt—Rh are catalytically active (“An LIF Study of Methane Oxidation over Noble Metal Gauze Catalysts” Abstracts 1999 Meeting Dallas, TX Assoc. Indust. Chem. Eng., p. 289b.) Those investigators also showed that 40-mesh nickel gauze did not ignite and there was no conversion of methane under methane partial oxidation conditions. It was concluded that bulk Ni metal is inert towards the conversion of methane to syngas (Davis, M., et al. Combustion and Flame 123: 159-174 (2000)).

U.S. Pat. Nos. 3,957,682 and 4,083,799 (assigned to Texaco, Inc.) disclose an Iconel metal screen consisting of about 50-95% nickel that is a methane steam reforming catalyst. In these processes the Ni catalyst is initially activated by heating in an oxygen-containing gas. Similarly, U.S. Pat. No. 5,112,527 (assigned to Amoco Corporation) also describes Ni as a reforming catalyst in the presence of steam, a gaseous lower alkane and air and in combination with a Group VIH metal having partial oxidation activity.

Japanese Pat. App. No. S59-184701 (assigned to Hiroshima Laboratory) describes certain Ni—Cr and Ni—Mb alloy powder catalysts that are active as methanol reformers.

Liao, M.-S., et al. (“Dissociation of methane on different transition metals,” J Mol. Catal. A: Chem. (1998) 136:185-194) give a theoretical comparison between Ru, Ir, Rh, Ni, Pd, Pt, Cu, Ag and Au. Those authors concluded that transition metals are very active, and coinage metals are inactive confirming previous experimental observations. Methane dissociation in the presence of adsorbed oxygen was also modeled.

Lapszewicz, J.A., et al. (Am.Chem. Soc., Div. Pet. Chem. (1993) 38:815-18) describe characteristics and performance of certain catalysts for partial oxidation of CH₄ to syngas. Jiang, X., et al. (Fenzi Cuihua (1994) 8:271-7) describe partial oxidation of CH₄ to syngahs: CH₄ activation over different transition metals. Jiang, X. (Shiyou Huagong (1998) 27:4-7) describes the partial oxidation of CH₄ to syngas over certain MgO-supported catalysts. Methane catalytic partial oxidation activities of (0.5%) Rh, Ru, Pt and Pd supported on MgO correlated with activity for exchange in D₂—CH₄ reactions. Order of activity was Rh>Ru>Pt>Pd, and CO selectivity improved with GHSV. Surface C was an intermediate for CO and CO₂ formation. A bimetallic 0.2% Rh-0.4% Ru on MgO was found to have outstanding synergistic behavior.

Gruenert, W., et al. (Z. Phys. Chem. (Munich) (1996) 197:49-65) describe active surface sites in the Rh-catalyzed partial oxidation of CH₄ to syngas. A Rh-gamma alumina exposed to either H₂/CH₄/CO2, or CH₄/O₂/N₂ yielded coexisting Rh(0), Rh(1) and Rh(3) surface species. Surface carbon was removed by CO₂ thru a reverse Boudouard reaction. Cooperative interaction between metallic and ionic Rh sites favored CH₄ activation.

Buyevskaya, O. V., et al. (CataL Lett. (1994) 29:249-60) discuss Rh-catalyzed partial oxidation of CH₄ to CO and H₂: transient studies on its mechanism, and Walter, K., et al. (Catal. Lett. (1994) 29:261-70) discuss Rh-catalyzed partial oxidation of CH₄ to CO and H₂: in-situ DRIFTS studies on surface intermediates. In a Rh-gamma alumina, CH₄ was dehydrogenated to C and H₂ (on reduced surface sites) and was simultaneously oxidized to CO₂ and H₂O. OH surface groups on the support contributed to CHX conversion to CO. Reverse Boudouard surface reaction between CO₂ and C contributed to CO formation as well.

Boucouvalas, Y., et al. (Catal. Lett. (1994) 29:249-60) disclose a method for the partial oxidation of CH₄ to syngas over Ru/TiO₂, and Bouvouvalas, Y., et al. (Catal. Lett. (1996) 40:189-195) disclose a method for the partial oxidation of methane to syngas via the direct reaction scheme over Ru/TiO₂. catalyst. All Group VIII catalysts promoted CH₄ combustion followed by H₂/CO₂ reforming. However, Ru/TiO₂ formed syngas directly.

Wang, D., et al. (J. Catal. (1996) 159:418-426) discribe a reaction mechanism and role of the support in the partial oxidation of CH₄ on Rh/Al₂O₃. A reaction scheme was presented on the basis of elementary reactions such as steam reforming, CO₂ reforming and water gas shift. This mechanism acknowledged the combustive behavior of Rh/AI₂O₃.

Nakamura, J., et al. discuss the production of syngas by partial oxidation of CH₄ over Group VIII metal catalysts. A variety of SiO₂-supported metals were studied. Rh, Ru and Ni produced CO₂ and H₂O below 700° K whereas CO and H₂ were produced above 700° K via CO₂/H₂O reforming of excess CH_{4.} Pt at 900° K also produced syngas, but reverse water-gas shift was active on this metal. Fe and Co only produced CO₂ and H₂O.

One disadvantage of many of the existing methods for catalytically converting hydrocarbon to syngas is the need, in many cases, to include steam in the feed mixture to suppress coke formation on the catalyst. Another drawback of some of the existing processes is that the catalysts that are employed often result in the production of significant quantities of carbon dioxide, steam, and C₂+ hydrocarbons. Also, in order to operate at very high flow rates, high pressure and using smaller catalyst beds in the smaller, short contact time reactors employed for partial oxidation processes, it is necessary to employ a highly permeable or porous, highly active and mechanically strong catalyst. None of the existing catalytic partial oxidation processes are capable of providing sufficiently high conversion of reactant gas and high selectivity of CO and H₂ reaction products without employing rare and costly catalysts. Accordingly, there is a continuing need for better, more economical processes and catalysts for the catalytic partial oxidation of hydrocarbons, particularly methane, or methane containing feeds, in which the catalyst retains a high level of activity and selectivity to carbon monoxide and hydrogen under conditions of high gas space velocity, elevated pressure and high temperature.

### SUMMARY OF THE INVENTION

The catalysts and methods of the present invention overcome many of the shortcomings of existing catalysts and processes for converting light hydrocarbons to syngas. The self-supporting nickel alloy catalysts are very porous, highly active and mechanically stronger than previously known partial oxidation catalysts and make possible the use of smaller catalyst beds in syngas production systems. One advantage of the preferred catalysts is that they retain a high level of activity and selectivity to carbon monoxide and hydrogen products under conditions of high gas space velocity, elevated pressure and high temperature. The reaction stoichiometry favors the catalytic partial oxidation reaction as the primary reaction catalyzed by the preferred catalysts. Another advantage provided by the preferred new catalysts and processes is that they are economically feasible for use under commercial-scale conditions. The new syngas production processes are particularly useful for converting gas from naturally occurring reserves of methane which contain carbon dioxide.

In accordance with the present invention, processes for preparing synthesis gas using bulk nickel alloy structures, or monoliths, for catalyzing the partial oxidation of any gaseous hydrocarbon having a low boiling point (e.g. C₁—C₅ hydrocarbons, particularly methane, or methane containing feeds) are provided. The new syngas production processes are particularly useful for converting gas from naturally occurring reserves of methane which contain carbon dioxide.

In accordance with certain embodiments the bulk Ni alloy catalyst is in any of various three-dimensional monolith forms such as disks or pieces of perforated metal foils, metal gauzes, metal foams expanded metal, and the like. In certain preferred embodiments the nickel alloy comprises nickel-chromium or nickel-cobalt-chromium. In other preferred embodiments the nickel alloy comprises Ni—Rh. The catalyst forms, or monoliths, may consist of up to 90% open area. Preferably the alloy metals are in their reduced states, e.g., Ni⁰ and Cr⁰ when contacting the reactant gas mixture. A nickel alloy catalyst having a three-dimensional form chosen from the group consisting of expanded nickel alloy metal sheets, nickel alloy gauzes, nickel alloy foams and perforated nickel alloy foils. In preferred embodiments the nickel alloy catalyst, when its nickel and alloy metal components are in a reduced oxidative state, has activity for catalyzing the net partial oxidation of a C₁—C₅ hydrocarbon in the presence of O₂ and reaction promoting conditions to a product gas mixture comprising H₂ and CO in a molar ratio of about 2:1, as in Equation (2), above.

Methods of making the bulk or monolith nickel alloy catalysts are also provided, in accordance with certain embodiments of the present invention. One method of making a metallic nickel alloy monolith catalyst that is active for catalyzing the partial oxidation of at least one C₁—C₅ hydrocarbon to a product gas comprising CO and H₂ includes applying a coating of at least one alloy metal, preferably chromium, over a metallic nickel substrate to yield a metal coated nickel monolith. The monolith has a sufficiently porous structure to allow reactant and/or product gases to flow through the catalyst bed of a reactor at a space velocity of at least 20,000 normal liters of gas per kilogram of catalyst per hour (NL/kg/h) when the catalyst is used in a reactor. The metals are alloyed by heating the coated monolith to about 1000 -1300° C. in a non-oxidizing environment to yield a nickel alloy monolith. The method may also include maintaining the monolith catalyst in its reduced state until it comes into contact with a reactant gas mixture in a reactor. This may be accomplished by heating the monolith in a reducing atmosphere prior to commencing contact with the hydrocarbon feedstock and oxygen containing gas, either in situ in the reactor or outside of the reactor.

Also in accordance with certain embodiments of the present invention are methods converting a 1-5 carbon-containing gaseous hydrocarbon, such as methane, to a product gas mixture comprising CO and H2. The processes include maintaining the catalyst and the reactant gas mixture at conversion promoting conditions of temperature and pressure during contact with the reactant gas mixture. Preferably the method includes maintaining the reactant gas mixture and the catalyst at a temperature of about 600-1,200° C. during contact. In some embodiments the temperature is maintained at about 700-1,100° C. In some embodiments of the methods the reactant gas mixture and the catalyst are maintained at a pressure of about 100-12,500 kPa during the contacting, and in some of the more preferred embodiments the pressure is maintained at about 130-10,000 kPa.

Certain embodiments of the methods of converting hydrocarbons to CO and H₂ comprise mixing a methane-containing feedstock and an oxygen-containing feedstock to provide a reactant gas mixture feedstock having a carbon:oxygen ratio of about 1.25:1 to about 3.3:1. In some of these embodiments, the mixing step is such that it yields a reactant gas mixture feed having a carbon:oxygen ratio of about 1.3:1 to about 2.2:1, or about 1.5:1 to about 2.2:1. In some of the most preferred embodiments the mixing step provides a reactant gas mixture feed having a carbon:oxygen ratio of about 2:1.

In some embodiments of the methods the said oxygen-containing gas that is mixed with the hydrocarbon comprises steam or CO₂, or a mixture of both. In some embodiments of the methods the C₁—C₅ hydrocarbon comprises at least about 50% methane by volume, and in some of the preferred embodiments the C₁—C₅ hydrocarbon comprises at least about 80% methane by volume.

Certain embodiments of the processes for converting hydrocarbons to comprise preheating the reactant gas mixture. Some embodiments of the processes comprise passing the reactant gas mixture over the catalyst at a space velocity of about 20,000 to about 100,000,000 normal liters of gas per kilogram of catalyst per hour (NL/kg/h). In certain of these embodiments, the gas mixture is passed over the catalyst at a space velocity of about 50,000 to about 50,000,000 NL/kg/h. In preferred embodiments the selectivity of the process for CO and H₂ products is such that the molar ratio of H₂:CO in the product gas mixture is about 2:1, the same as in Equation (2), above. These and other embodiments, features and advantages of the present invention will become apparent with reference to the following description.

### DETAILED DESCRIPTION OF PREFERRED EMBODIMENTS

Bulk or monolith metallic nickel alloy catalysts capable of catalytically converting C₁—C₅ hydrocarbons to CO and H₂ are prepared as described in the following examples. These catalysts may have any of various 3-D forms such as foils, gauzes, foams, expanded metal, and the like. Preferably, however, the bulk nickel alloy catalyst is in the form of one or more disks of perforated, alloyed Ni foil.

Contrary to the general consensus that bulk nickel is not useful for catalyzing the synthesis of syngas from methane, the present inventors have demonstrated that by properly activating a bulk nickel catalyst structure in a reducing environment, an active, selective and productive syngas catalyst is produced, as disclosed in concurrently filed U.S. Pat. Application No.______ entitled “Bulk Nickel Catalysts and Processes for Production of Syngas,” the disclosure of which is incorporated herein by reference. The inventors now demonstrate that bulk nickel alloy catalyst structures prepared as described in the following examples are highly active catalysts with sufficient mechanical strength to withstand high pressures and temperatures and permit a high flow rate of reactant and product gases when employed on-stream in a short contact time reactor for synthesis gas production.

Any suitable reaction regime may be applied in order to contact the reactants with the catalyst. One suitable regime is a fixed bed reaction regime, in which the catalyst is retained within a reaction zone in a fixed arrangement. The bulk Ni alloy catalyst is employed in the fixed bed regime, retained using fixed bed reaction techniques that are well known and have been described in the literature.

### EXAMPLE 1

Ni—Cr Bulk Catalyst

A bulk Ni—Cr alloy catalyst was prepared from a perforated Ni foil substrate which was perforated by photofabrication. The substrate disks were 12 mm O.D., 0.025 mm thick, with square perforations with a 0.295 mm side, located on a 60-mesh square grid. Alternatively, another perforation technique such as abrasive drilling, laser drilling, electron beam drilling, electric discharge machining, stretching of a slitted foil, or another well known technique described in the literature could be used to perforate the disks.

A chromium coating was deposited onto one side or face of a perforated Ni substrate using a physical vapor deposition system. The perforated nickel substrate was in the form of a 12 mm diameter×0.004 inch (0.1016 mm) thick disk. A number of these substrate disks were processed at the same time. The vapor deposition system comprised a stainless chamber (initially cryopumped down to a base pressure in the low 10⁶ Torr range), a vertically oriented rotating cylindrical substrate holder and a set of magnetron sputter vaporization sources located around the holder at different axial heights. This reactor design is suitable for the combinatorial synthesis of a multitude of coating compositions in a single pumpdown. In this test, several expanded Ni metal disks (each about 12 mm in diameter and 0.1016 mm thick), were treated as follows: (a) the substrates were wiped with a lint-free acetone-impregnated cloth and introduced to the vapor deposition chamber (b) after attainment of base pressure, the chamber was back filled with flowing oxygen kept at 20 mTorr, (c) the substrate holder was RF glow discharge ignited at 13.56 MHz with a bias voltage of 175 volts for 15 minutes, (d) the flowing gas was switched from oxygen to argon and the substrate holder was set in motion at 5 rpm, (e) the Cr magnetron vaporization source was ignited with a DC power supply for a period of time necessary to achieve a given coating thickness distribution. Such thickness distribution is deternined by the targeted stoichionetry of the bulk catalyst, which is governed by the relative masses of substrate ans coating. Altenatively, the Ni substrates can be coated with chromium metal using techniques such as electrolytic deposition, electroless deposition, thermal spraying, chemical vapor deposition, and other processes that are well-known and have been described in several references, such as Handbook of Thin Film Technology, L.Maissel and R.Glang (eds.), McGraw-Hill (1970), or Thin Film Processes, J.A.Thornton and W.Kern (eds.), Academic Press (1978).

The disks were spot welded into disk-paks of up to twenty (with all disks in the welded pak having the same Cr:Ni atomic stoichiometric ratio), and subsequently diffusion treated in Ar-H₂ at 1000° C. for 4 hours. The high temperature treatment in a non-oxidizing environment effected the solid state interdiffuision between the coating and the Ni substrate. As a result, the chromium became diffused into the Ni substrate atomic lattice to produce a bulk Ni—Cr alloy catalyst, in the form of a perforated foil disk that was compositionally homogenized across its thickness. Eight disk-paks were stacked together to yield a bed having a decreasing Cr concentration, from feed entry to product exit, as indicated in Table 2.

TABLE 2
Composition of Ni—Cr Paks*

| Pak Order | Atomic % Cr |
|---|---|
| 1 | 14.5 |
| 2 | 10.1 |
| 3 | 10.9 |
| 4 | 3.7 |
| 5 | 4.2 |
| 6 | 0.8 |
| 7 | 1.1 |
| 8 | 0.0 |

determined by Inductive Coupled Plasma Spectroscopy

The eighth disk-pak had no Cr coating and was not exposed to the diffusion treatment. The total bed height was 6 mm. The bulk Ni—Cr perforated metal disks were charged to the reactor for testing, as described in the section entitled “Test Procedure.” Evaluation at 1055° C. at a total flow rate of 7.5 SLPM with a feed of 60% CH₄, 30% O₂ and 10% N₂ resulted in 77% CH₄ conversion, 100% O₂ conversion, 99% CO selectivity and 92% H₂ selectivity.

Although spot welding is a preferred technique for joining the peripheries of adjacent disks, another technique for connecting the disks could be substituted to make the desired thermally conductive joint. This type of “thermal integration” of a multi-disk catalyst bed is sometimes desirable due to the localized presence of highly exothermic reactions during the oxidative conversion of methane (combustion, gas channeling, uneven distribution of catalyst, etc.) which can generate hot spots within the catalyst and potentially lead to melting of the catalyst bed. Refractory ceramic supports are conventionally used to address such melting problem; however, ceramic materials are well known for their poor thermal shock resistance and, therefore, are also liable to fail when hot spots form within the catalyst. When combustive reactions are present, the excess methane and the full oxidation products can react endothermically to generate hydrogen and/or CO. Under such circumstances, a thermally conductive support facilitates the integration of exothermic and endothermic reactions, which extends the lifetime of the catalyst by reducing the temperature of the regions exposed to exothermic conditions. Thermal runaway conditions can take place when the catalyst irreversibly degrades into products that selectively accelerate exothermic reactions or reduce the incidence of endothermic reactions or critically reduce the thermal integration within the catalyst.

### EXAMPLE 2

Ni—Co—Cr Bulk Catalyst

A bulk Ni—Co—Cr alloy catalyst was prepared from a perforated Ni foil substrate disk as described in Example 1, except that chromium and cobalt metals were simultaneously deposited onto the nickel substrate disks. Cr and Co magnetron vaporization sources were ignited with separate DC power supplies for a period of time necessary to achieve a given coating thickness distribution. The Co—Cr coated disks were spot welded into disk paks of up to twenty disks (with all disks in the welded pak having the same Cr:Co:Ni atomic stoichiometric ratio), and subsedquently diffusion treated in Ar-H₂ at 1,000° C. for 4 hours, to form disks that were compositionally homogenized across their thickness, as described above. Eight disk-paks were stacked together to yield a bed having a decreasing CoCr concentration, from feed entry to product exit, as indicated in Table 3.

TABLE 3
Composition of Ni—Co—Cr Paks*

| Pak Order | Atomic % Cr | Atomic % Co |
|---|---|---|
| 1 | 11.4 | 3.1 |
| 2 | 7.5 | 1.9 |
| 3 | 8.6 | 2.1 |
| 4 | 2.1 | 0.5 |
| 5 | 2.4 | 0.5 |
| 6 | 0.6 | 0.1 |
| 7 | 0.8 | 0.1 |
| 8 | 0.0 | 0.0 |

*determined by Inductive Coupled Plasma Spectroscopy

The eighth disk-pack had no CoCr coating and was not exposed to the diffusion treatment. The total bed height was 6 mm. The bulk Ni—Co—Cr perforated metal disks were charged to the reactor for testing, as described in the section entitled “Test Procedure.” Evaluation at 820° C. at a flow rate of 7.5 SLPM with a feed of 60% CH₄, 30% O₂ and 10% N₂ resulted in 82% CH₄ conversion, 100% O₂ conversion, 99% CO selectivity and 96% H₂ selectivity.

### EXAMPLE 3

Ni—Rh Bulk Catalyst

A perforated metal Ni—Rh alloy monolith was prepared from perforated Ni metal foil similarly to the procedure described in Example 2. In separate tests, the Rh coating was applied to both faces of the expanded Ni metal disks. Cross-sectional metallographic analysis of the alloyed materials showed that the differential diffusion rates of rhodium and nickel generate vacancies at the Rh—Ni interface, apparently due to the Kirkendall effect. These vacancies move with the advancing interface, and there appears to be a preferential surface enrichment of Ni in the resulting bulk Ni—Rh alloys. The Kirkendall vacancies eventually coalesce into pores which remain within the bulk of the diffusion couple (in the case of two-sided coated disks), or are swept to the original Ni surface (in the case of one-sided coated disks), where there are annihilated. In both cases, the effect on residual mechanical properties is expected to be minimal. The phase distribution in the Ni—Cr and Ni—Co—Cr bulk alloy catalysts described in Examples 1-2, however, are expected to generate Kirkendall effects that are different than those reported for the Ni—Rh system.

Although chromium, cobalt and rhodium are described in the foregoing examples, other metals such as manganese, molybdenum, tungsten, tin, rhenium, phosphorous, bismuth, iron, vanadium, and copper could be substituted for, or coated along with the Cr, Co or Rh alloying metal, and are expected to provide satisfactory nickel alloy monoliths for catalyzing the conversion of light hydrocarbons to synthesis gas. Also, transition metals such as Co and Fe are expected to serve as suitable substrate metals, in place of Ni, in preparing a satisfactory self-supporting bulk catalyst in a manner similar to preparing the Ni alloy catalysts described in the foregoing examples.

### EXAMPLE 4

Expanded Ni Metal Substrate

A bulk Ni substrate is prepared from an expanded Ni metal sheet that has been sequentially slit and stretched by shaped tools which determine the form, dimensions and number of openings in the expanded metal sheet. The slit-stretch fabrication process can provide an expanded nickel metal sheet that is extremely light and open, as much as 90% open area. Strand dimensions (width and thickness) and weight per square inch are design parameters which determine the levels of openness, mechanical strength, surface area and thermal conduction of the expanded sheet. These parameters influence the operational characteristics of catalytic beds fabricated with such sheets, particularly their pressure drop behavior and their ability at integrating exothermic and endothermic reactions. The complex phenomenology of the oxidative conversion reactions for methane, when using catalytic expanded sheets, indicates that statistically designed experimental protocols can readily identify the limit for the ranges that each one of these parameters. The expanded metal structure has certain advantages over other open area materials for forming the substrate for a monolith catalyst. For example, conventional perforation processes use one square foot of non-perforated material to produce only one square foot of perforated product. For expanded metals, however, there is no waste and one square foot of material results in two or three times and even more of perforated product.

Disks 12 mm in diameter and 0.004″ thick are prepared from a sheet of expanded Ni metal obtained from Exmet Corporation of Naugatuck, CT. Preferably the Ni content is about 100%. A suitable expanded Ni metal is Exmet 4 Ni X—4/0. The long-way of the diamond (LWD) shape is 2 mm and the short-way of the diamond (SWD) shape is 1 mm. The disks are initially cleaned by the following procedure: The disks are soaked in 50 ml of acetone for 30 minutes, followed by immersion in 20 ml of 20 wt % NaOH at room temperature for 20 minutes. This NaOH solution with the immersed disks is then heated to 80° C. and held for 20 minutes at 80° C. Subsequently, the disks are rinsed with deionized water until the wash water is neutral. The disks are then dried in a vacuum oven at 110° C. for 2 hours prior to charging to the reactor for testing. Suitable expanded Ni metal sheets from which the disks may be formed are listed in Table 1, although any other expanded Ni metal configuration may be employed as long as the pressure drop of the final catalyst is acceptable for the particular syngas production system.

TABLE 1

| | Mesh Dimensions | Mesh Dimensions | Thickness of | Strand |
|---|---|---|---|---|
| Mesh | (from center to center of joints) | (from center to center of joints) | Original Material | Width |
| Designation | Long Way of the Diamond | Short Way of the Diamond | (min/max.) | (min./max.) |
| (size) | (inches) | (min./max.) (inches) | (inches) | (inches) |
| 3/16 | .506 | .200-.279 | .010/.040 | .015/.070 |
| 1 | .405 | .200-.235 | .003/.025 | .007/.055 |
| 1 HX | .405 | .214-.240 | .010/.040 | .015/.060 |
| 1/0 | .280 | .100-.150 | .003/.025 | .007/.055 |
| 1/0 HX | .278 | .166-.200 | .010/.035 | .015/.050 |
| 1/23 | .236 | .126-.143 | .003/.035 | .005/.050 |
| 1/22 | .2284 | .107-.120 | .005/.030 | .010/.040 |
| 3/32 | .215 | .107-.143 | .002/.030 | .005/.045 |
| 2/0 | .187 | .077-.091 | .002/.020 | .007/.035 |
| 2/0 HX | .190 | .118-.143 | .005/.030 | .010/.045 |
| 2/0 E | .187 | .056-.071 | .002/.010 | .007/.035 |
| 2/1 | .180 | .091-.111 | .003/.026 | .005/.026 |
| 3/2 HX | .1575 | .102-.115 | .005/.026 | .010/.040 |
| 3/1 | .140 | .080-.091 | .002/.024 | .004/.026 |
| 3/0 | .125 | .053-.071 | .002/.015 | .004/.020 |
| 3/0 HX | .125 | .077-.083 | .005/.020 | .007/.025 |
| 4/4 HX | .105 | .071-.074 | .005/.026 | .005/.026 |
| 4/3 | .100 | .050-.059 | .002/.015 | .004/.020 |
| 4/3 HX | .100 | .063-.069 | .004/.018 | .005/.022 |
| 4/2 LIX | .093 | .063-.065 | .004/.018 | .005/.022 |
| 4/1 | .080 | .048-.053 | .002/.015 | .004/.020 |
| 4/0 | .077 | .033-.046 | .002/.012 | .004/.020 |
| 5/0 | .050 | .027-.031 | .002/.010 | .004/.012 |
| 6/0 | .031 | .021-.024 | .002/.007 | .004/.010 |

Source: Exmet Corporation, Naugatuck, CT

The expanded metal structure has certain advantages over other open area materials for forming the substrate for a monolith catalyst. For example, one square foot of perforated material produces only one square foot of product. For expanded metals, however, there is no waste and one square foot of material results in two or three times and even more of finished product.

### EXAMPLE 5

Ni—Cr Expanded Metal Monolith Catalyst

An expanded metal Ni alloy monolith is prepared from an expanded Ni metal foil that had been simultaneously slit and stretched by shaped tools. A chromium coating is deposited onto one side or face of an expanded Ni substrate using a physical vapor deposition system. The expanded nickel substrate is in the form of a 12 mm diameter×0.004 inch (0.1016 mm) thick disk. A number of these substrate disks can be processed at the same time. The vapor deposition system comprises a stainless chamber (initially cryopumped down to a base pressure in the low 10⁻⁶ Torr range), a vertically oriented rotating cylindrical substrate holder and a set of magnetron sputter vaporization sources located around the holder at different axial heights. This reactor design is suitable for the combinatorial synthesis of a multitude of coating compositions in a single pumpdown. Several expanded Ni metal disks (each about 12 mm in diameter and 0.1016 mm thick), suitable for forming a catalyst bed in a reduced-scale reactor, are treated as follows: (a) the substrates are wiped with a lint-free acetone-impregnated cloth and introduced to the vapor deposition chamber (b) after attainment of base pressure, the chamber is back filled with flowing oxygen kept at 20 mTorr, (c) the substrate holder is RF glow discharge ignited at 13.56 MHz with a bias voltage of 175 volts for 15 minutes, (d) the flowing gas is switched from oxygen to argon and the substrate holder is set in motion at 5 rpm, (e) the Cr magnetron vaporization source is ignited with a DC power supply for a period of time necessary to achieve a given coating thickness distribution. Such thickness distribution is determined by the targeted stoichiometry of the bulk catalyst, which is governed by the relative masses of substrate and coating. Alternatively, the Ni substrates can be coated with chromium metal using techniques such as electrolytic deposition, electroless deposition, thermal spraying, chemical vapor deposition, and other processes that are well-known and have been described in several references, such as Handbook of Thin Film Technology, L. Maissel and R. Glang (eds.), McGraw-Hill (1970), or Thin Film Processes, J. A. Thornton and W. Kern (eds.), Academic Press (1978).

The Ni—Cr expanded metal disks are then exposed to a high temperature of about 1,100-1,300° C. in a non-oxidizing environment to effect the solid state interdiffusion between the coating and the Ni substrate. In this way an expanded nickel-chromium metal alloy is formed of homogeneous Ni—Cr alloy composition across its thickness. The chromium becomes diffused into the Ni substrate atomic lattice to produce a bulk Ni—Cr alloy catalyst in the form of an expanded metal disk.

The bulk Ni—Cr expanded metal disks may then be charged to the reactor for testing, as described in the section entitled “Test Procedure.”

While representative examples of perforated foil nickel alloy catalysts and expanded nickel metal alloy catalysts have been described in the foregoing examples, other bulk Ni alloy catalyst forms could be substituted in the syngas production process with satisfactory results. Some alternative forms are Ni alloy gauzes, metal foams, and the like, as long as the extent of openness and mechanical strength of the monolith catalyst is compatible with on-stream conditions of at least 100-12,500 kPa pressure, temperatures of about 600-1,200° C. and flow rates of at least 2×10⁴−1×10⁸ NL/kg/h. One three-dimensional form might be preferred over another, depending on the particular requirements that are dictated by the intended use. In producing woven wire, cloth, or gauze the process must start with wire, drawn and annealed to the correct diameter. Depending on their rigidity, the intersecting strands are relatively free to move past each other, inducing failure mechanisms facilitated by the frictional wear between the intersecting strands. For this reason, the woven materials are less preferred as starting materials for preparing the bulk Ni alloy catalysts. With the expanded or the perforated Ni metal, however, the strands of the monolith are integral, providing a remarkably strong material. A variety of suitable bulk nickel substrate materials from which the catalysts can be prepared are commercially available, for example, from Goodfellows Corp., Berwyn, PA. There are also techniques for making wire cloth, metal foams, and three-dimensional shapes that are formed using appropriate metal shaping or forming techniques that have been well described in the literature. For example, a suitable method of making porous metal foams is described in PCT publication WO 97/31738 (assigned to Astro Met, Inc.). Techniques which enhance the stiffness of the metal foam to better support a large foam structure are preferred. Also, techniques that reduce or eliminate impurities in the metal foam, which hinder the catalytic performance, are desirable.

Test Procedure

Several schemes for carrying out catalytic partial oxidation (CPOX) of hydrocarbons in a short contact time reactor have been described in the literature. For example, L.D. Schmidt and his colleagues at the University of Minnesota describe a millisecond contact time reactor in U.S. Pat. No. 5,648,582 and in J Catalysis 138, 267-282 (1992) for use in the production of synthesis gas by direct oxidation of methane over a catalyst such as platinum or rhodium. A general description of major considerations involved in operating a reactor using millisecond contact times is given in U.S. Pat. No. 5,654,491. The disclosures of the above-mentioned references are incorporated herein by reference. In the present studies, the above-described catalysts were evaluated using a conventional flow apparatus with a 19 mm O.D.×13 mm I.D. and 12″ long quartz reactor. A ceramic foam of 99% Al₂O₃ (12 mm OD×5 mm of 45 ppi) were placed before and after the catalyst as radiation shields. The inlet radiation shield also aided in uniform distribution of the feed gases. An Inconel sheathed, single point K-type (Chromel/Alumel) thermocouple (TC) was placed axially inside the reactor touching the top (inlet) face of the radiation shield. A high temperature S-Type (Pt/Pt 10% Rh) bare-wire TC was positioned axially touching the bottom face of the catalyst and was used to indicate the reaction temperature. The catalyst and the two radiation shields were sealed tight against the walls of the quartz reactor by wrapping them radially with a high purity (99.5%) alumina paper. A 600 watt band heater set at 90% electrical output was placed around the quartz tube, providing heat to light off the reaction and to preheat the feed gases. For example, in some instances the feed gases may be preheated up to about 600° C. to ignite the reaction. The bottom of the band heater corresponded to the top of the upper radiation shield.

In addition to the TCs placed above and below the catalyst, the reactor also contained two axially positioned, triple-point TCs, one before and another after the catalyst. These triple-point thermocouples were used to determine the temperature profiles of reactants and products subjected to preheating and quenching, respectively. Preheating was done with the 600 watt band heater and quenching was accomplished with water cooling coils wrapped around the external surface of the lower section of the tubular reactor.

All test runs were done at a reactant gas feed mixture of CH₄:O₂ at a molar ratio of 2: 1, and at a pressure of 5 psig (136 kPa). The reactor effluent was analyzed using a gas chromatograph equipped with a thermal conductivity detector. The C, H and O mass balance were all between 98-102%. The extent of CH₄ and O₂ conversion was measured and the product selectivity for CO and H₂ products was determined. The representative bulk nickel alloy catalysts provide at least about 77% CH₄ conversion, about 100% O₂ conversion and selectivity for CO and H₂ products of at least about 95% and 71%, respectively. A representative bulk Ni—Cr alloy catalyst prepared according to Example 1 demonstrated 77%:100% CH₄:O₂ conversion and selectivity of 99%:92% CO/H₂ when the feedstock comprised 60% CH₄, 30% O₂ and 10% N₂. The ratio of H₂/CO is about 1.86. A representative bulk Ni—Co—Cr alloy catalyst prepared according to Example 2 demonstrated 82%:100% CH₄:O₂ conversion and selectivity of 99%:96% CO/H₂ when the feedstock comprised 60% CH₄, 30% O₂ and 10% N₂. The ratio of H₂/CO is about 1.94. In each case, the observed stoichiometry of reactants and products is consistent with a net partial oxidation reaction, suggesting that the catalytic partial oxidation of methane was the predominant oxidation reaction taking place.

Process of Producing Syngas

A feed stream comprising a light hydrocarbon feedstock, such as methane, and an oxygen-containing gas is contacted with a bulk Ni alloy catalyst, prepared as described in one of the foregoing Examples. The catalyst is contained in a reaction zone maintained at conversion-promoting conditions effective to produce an effluent stream comprising carbon monoxide and hydrogen. Preferably a millisecond contact time reactor is employed, equipped for either axial or radial flow of reactant and product gases. The hydrocarbon feedstock may be any gaseous hydrocarbon having a low boiling point, such as methane, natural gas, associated gas, or other sources of light hydrocarbons having from 1 to 5 carbon atoms. The hydrocarbon feedstock may be a gas arising from naturally occurring reserves of methane which contain carbon dioxide. Preferably, the feed comprises at least 50% by volume methane, more preferably at least 75% by volume, and most preferably at least 80% by volume methane.

The hydrocarbon feedstock is in the gaseous phase when contacting the catalyst. The hydrocarbon feedstock is contacted with the catalyst as a mixture with an oxygen-containing gas, preferably pure oxygen. The oxygen-containing gas may also comprise steam and/or CO₂ in addition to oxygen. Alternatively, the hydrocarbon feedstock is contacted with the catalyst as a mixture with a gas comprising steam and/or CO₂. It is preferred that the methane-containing feed and the oxygen-containing gas are mixed in such amounts to give a carbon (i.e., carbon in methane) to oxygen (i.e., oxygen) ratio from about 1.25:1 to about 3.3:1, more preferably, from about 1.3:1 to about 2.2:1, and most preferably from about 1.5:1 to about 2.2:1, especially the stoichiometric ratio of 2:1. The process is operated at atmospheric or superatmospheric pressures, the latter being preferred. The pressures may be from about 100 kPa to about 12,500 kPa, preferably from about 130 kPa to about 10,000 kPa. The process is preferably operated at temperatures of from about 600° C. to about 1,200° C. preferably from about 700° C., to about 1,100° C. The hydrocarbon feedstock and the oxygen-containing gas are preferably pre-heated before contact with the catalyst. The hydrocarbon feedstock and the oxygen-containing gas are passed over the catalyst at any of a variety of space velocities. The gas flow rate is preferably regulated such that the contact time for the portion of reactant gas mixture that contacts the catalyst is no more than about 10 milliseconds and more preferably from about 1 to 5 milliseconds. This ultra short contact time is accomplished by passing the reactant gas mixture over one of the above-described catalysts at a space velocity, stated as normal liters of gas per kilogram of catalyst per hour, of about 20,000 to about 100,000,000 NL/kg/h, preferably about 50,000 to about 50,000,000 NL/kg/h. The product gas mixture emerging from the reactor are, optionally, sampled for analysis of products, including CH₄, O₂, CO, H₂ and CO₂, and then harvested or routed to another application such as a Fischer-Tropsch process.

While the preferred embodiments of the invention have been shown and described, modifications thereof can be made by one skilled in the art without departing from the spirit and teachings of the invention. The embodiments described herein are exemplary only, and are not intended to be limiting. For example, pure methane was employed in the representative test procedures, however, any light hydrocarbon (i.e., C₁—C₅) gaseous feedstock could also serve as a feedstock for the catalytic partial oxidation reaction catalyzed by the new bulk Ni alloy catalysts. Many variations and modifications of the invention disclosed herein are possible and are within the scope of the invention. For example, the 3—D shapes described by the inventors are only a few of the many workable configurations the new bulk catalysts may assume and which will provide the requisite porosity and mechanical strength. Accordingly, the scope of protection is not limited by the description set out above, but is only limited by the claims which follow, that scope including all equivalents of the subject matter of the claims. The disclosure of U.S. Provisional Pat. Application No. 60/175,043 filed Jan. 7, 2000, and the disclosures of all patents and publications cited herein are incorporated herein by reference.

What is claimed is:

1. A method of converting a C₁—C₅ hydrocarbon to a product gas mixture comprising CO and H₂, the method comprising:
in a millisecond contact time reactor, contacting a reactant gas mixture comprising said hydrocarbon and a source of O₂ with a catalytically effective amount of a compositionally homogeneous metallic nickel alloy monolith catalyst having a structure that is sufficiently permeable to allow reactant and/or product gases to flow through said monolith such that a portion of reactant gas mixture contacts said monolith for no more than about 10 milliseconds when said monolith is employed in a catalyst bed of a millisecond contact time syngas production reactor, said metallic nickel alloy monolith comprising nickel and at least one alloy metal in their reduced metal states;
maintaining said monolith at conversion promoting conditions of temperature, reactant gas composition and pressure and reactant gas/catalyst contact time during said contacting whereby a net partial oxidation reaction is catalyzed by said nickel alloy monolith.

2. The method of claim 1 further comprising preparing a catalyst bed comprising a plurality of nickel alloy disks.

3. The method of claim 2 wherein said contacting comprises contacting said reactant gas mixture with a catalyst bed comprising a plurality of nickel alloy disks wherein at least a portion of the perimeter of adjacent disks are joined together to form a thermally conductive connection between said adjacent disks.

4. The method of claim 1 wherein said contacting comprises contacting a reactant gas mixture comprising said hydrocarbon and a source of oxygen with a catalytically effective amount of a metallic nickel-chromium alloy monolith having a sufficiently permeable structure to allow reactant and product gases to flow through the catalyst bed of a reactor at a space velocity of at least 20,000 normal liters of gas per kilogram of catalyst per hour (NL/kg/h) when said catalyst is used in a reactor.

5. The method of claim 1 wherein said step of contacting comprises contacting a reactant gas mixture comprising said hydrocarbon and a source of oxygen with a catalytically effective amount of a metallic nickel alloy monolith having a perforated foil structure sufficiently porous to allow reactant and product gases to flow through the catalyst bed of a reactor at a rate of at least 2.5 SLPM when said catalyst is used in a reactor, said metallic nickel alloy monolith comprising nickel and at least one alloy metal in their reduced metal states.

6. The method of claim 1 wherein said step of contacting comprises contacting a reactant gas mixture comprising said hydrocarbon and a source of oxygen with a catalytically effective amount of a metallic nickel alloy monolith having a nickel alloy metal foam structure sufficiently porous to allow reactant and product gases to flow through the catalyst bed of a reactor at a rate of at least 2.5 SLPM when said catalyst is used in a reactor, said metallic nickel alloy monolith comprising nickel and at least one alloy metal in their reduced metal states.

7. The method of claim 1 wherein said step of contacting comprises contacting a reactant gas mixture comprising said hydrocarbon and a source of oxygen with a catalytically effective amount of a metallic nickel alloy catalyst having a metal foam structure sufficiently porous to allow reactant and product gases to flow through the catalyst bed of a reactor at a rate of at least 2.5 SLPM when said catalyst is used in a reactor, said metallic nickel alloy monolith comprising nickel and at least one alloy metal in their reduced metal states.

8. The method of claim 1 wherein said step of contacting comprises contacting a reactant gas mixture comprising said hydrocarbon and a source of oxygen with a catalytically effective amount of a metallic nickel alloy catalyst having a gauze structure sufficiently porous to allow reactant and product gases to flow through the catalyst bed of a reactor at a rate of at least 2.5 SLPM when said catalyst is used in a reactor, said metallic nickel alloy monolith comprising nickel and at least one alloy metal in their reduced metal states.

9. The method of claim 1 wherein said step of contacting comprises contacting a reactant gas mixture comprising said hydrocarbon and a source of oxygen with a catalytically effective amount of a metallic nickel alloy monolith having an expanded metal structure sufficiently porous to allow reactant and product gases to flow through the catalyst bed of a reactor at a rate of at least 2.5 SLPM when said catalyst is used in a reactor, said metallic nickel alloy monolith comprising nickel and at least one alloy metal in their reduced metal states.

10. The method of claim 1 wherein said step of maintaining said catalyst at conversion promoting conditions during said contacting includes maintaining a temperature of about 600-1,200° C.

11. The method of claim 10 wherein said step of maintaining conversion promoting conditions comprises maintaining a temperature of about 700-1,100° C.

12. The method of claim 1 wherein said step of maintaining conversion promoting conditions during said contacting includes maintaining a pressure of about 100-12,500 kPa.

13. The method of claim 12 wherein said step of maintaining conversion promoting conditions during said contacting includes maintaining a pressure of about 130-10,000 kPa.

14. The method of claim 1 further comprising mixing a methane-containing feedstock and an O₂-containing feedstock to provide a reactant gas mixture feedstock having a carbon:oxygen ratio of about 1.25:1 to about 3.3:1.

15. The method of claim 14 wherein said mixing provides a reactant gas mixture feed having a carbon:oxygen ratio of about 1.3:1 to about 2.2:1.

16. The method of claim 14 wherein said mixing provides a reactant gas mixture feed having a carbon:oxygen ratio of about 1.5:1 to about 2.2:1.

17. The method of claim 16 wherein said mixing provides a reactant gas mixture feed having a carbon:oxygen ratio of about 2:1.

18. The method of claim 1 wherein said oxygen-containing gas further comprises steam, CO₂, or a combination thereof

19. The method of claim 1 further comprising mixing a hydrocarbon feedstock and a gas comprising steam and/or CO₂ to provide said reactant gas mixture.

20. The method of claim 1 wherein said C₁—C₅ hydrocarbon comprises at least about 50 % methane by volume.

21. The method of claim 20 wherein said C₁—C₅ hydrocarbon comprises at least about 80 % methane by volume.

22. The method of claim 21 further comprising preheating said reactant gas mixture.

23. The method of claim 1 further comprising passing said reactant gas mixture over said catalyst monolith at a space velocity of about 20,000 to about 100,000,000 normal liters of gas per kilogram of catalyst per hour (NL/kg/h).

24. The method of claim 23 wherein said step of passing said reactant gas mixture over said catalyst monolith comprises passing said mixture at a space velocity of about 50,000 to about 50,000,000 NL/kg/h.

25. The method of claim 1 further comprising retaining said catalyst monolith in a fixed bed reaction zone.

26. A method of converting a C₁—C₅ hydrocarbon feedstock comprising at least about 50 vol % methane to a product gas mixture comprising CO and H₂, the method comprising:
mixing a gaseous C₁—C₅ hydrocarbon-containing feedstock and an oxygen-containing feedstock to provide a reactant gas mixture feedstock having a carbon:oxygen ratio of about 1.25:1 to about 3.3:1;
in a millisecond contact time reactor, contacting said reactant gas mixture feedstock with a catalytically effective quantity of a reduced metallic nickel-chromium alloy monoliths, said monoliths together having sufficient permeability to allow reactant and product gases to flow through a catalyst bed of said reactor at such rate that the contact time for a portion of reactant gas mixture that contacts said monoliths is no more than about 10 milliseconds when said catalyst is used in said reactor;
passing said reactant gas mixture feedstock over said monoliths at such flow rate that the contact time for a portion of reactant gas mixture that contacts said monoliths is not more than about 10 milliseconds;
during said contacting, maintaining said monoliths at a temperature of about 600-1,200° C.;
during said contacting, maintaining said monoliths at a pressure of about 100-12,500 kPa; and
during said contacting, optionally, adjusting said hydrocarbon and said oxygen concentration in said reactant gas mixture feedstock to a carbon:oxygen ratio is about 1.25:1 to about 3.3: 1, such that the molar ratio of H₂:CO in said product gas mixture is about 2:1.

27. A method of making a metallic nickel alloy monolith catalyst that is active for catalyzing the net partial oxidation of at least one C₁—C₅ hydrocarbon in the presence of O₂ to a product gas comprising CO and H₂ in a millisecond contact time reactor under reaction promoting conditions, the method comprising:
applying a coating of at least one alloy metal over a metallic nickel substrate to yield a metal coated nickel monolith having a sufficiently porous structure to allow reactant and product gases to flow through the catalyst bed of a reactor at a space velocity of at least 20,000 normal liters of gas per kilogram of catalyst per hour (NL/kg/h) when said catalyst is used in a reactor;
optionally, attaching at least two adjacent monoliths by way of a thermally conductive connection;
heating said coated monolith to about 1,100° C. -1,300° C. in a non-oxidizing environment whereby solid state interdiffusion between said at least one alloy metal and said Ni substrate is effected to yield a nickel alloy monolith; and
reducing said monolith nickel alloy catalyst prior to contacting said catalyst with a reactant gas mixture when said catalyst is used for syngas production.

28. The method of claim 27 wherein said applying comprises applying a coating of at least chromium over a metallic nickel substrate to yield a chromium coated nickel monolith having a sufficiently porous structure to allow reactant and product gases to flow through the catalyst bed of a reactor at a space velocity of at least 20,000 normal liters of gas per kilogram of metal per hour (NL/kg/h) when said catalyst is used in a reactor.

29. The method of claim 27 further comprising shaping said metallic nickel alloy monolith.

30. The method of claim 29 wherein said shaping said metallic nickel alloy monolith comprises forming a nickel alloy foam.

31. The method of claim 29 wherein said shaping said metallic nickel alloy monolith comprises perforating a metal foil.

32. The method of claim 29 wherein said shaping said metallic nickel alloy monolith comprises forming at least one substrate piece chosen from the group consisting of nickel gauze and expanded nickel metal.

33. A nickel alloy catalyst having a three-dimensional form chosen from the group consisting of expanded metal sheets, gauzes, foams, perforated foils and corrugated foils, comprising nickel and an alloy metal chosen from the group consisting of chromium, cobalt, and rhodium, and mixtures thereof, and, when said nickel and alloy metal components are in the reduced oxidative state, having activity for catalyzing the net partial oxidation of a C₁—C₅ hydrocarbon in the presence of O₂ and partial oxidation promoting conditions to a product gas mixture comprising H₂ and CO in a molar ratio of about 2:1.

34. The catalyst of claim 33 wherein said nickel alloy comprises Ni—Cr.

35. The catalyst of claim 33 wherein said nickel alloy comprises Ni—Cr—Co.

36. The catalyst of claim 33 wherein said nickel alloy comprises Ni—Rh.

37. The catalyst of claim 33 wherein said three-dimensional form comprises up to 90% open area.

38. The catalyst of claim 33 wherein said catalyst comprises a plurality of thermally integrated monoliths.

39. The catalyst of claim 33 wherein the mechanical strength of said catalyst is sufficient to withstand an on-stream pressure of at least 100 kPa.

40. The catalyst of claim 33 wherein the macroporosity of said catalyst is sufficient to allow reactant and product gases to flow through the catalyst bed of a reactor at a space velocity of at least 20,000 normal liters of gas per kilogram of catalyst per hour (NL/kg/h) when said catalyst is used in a short contact time reactor.
